(19) United States
(12) Patent Application Publication
(10) Pub. No.: US 2016/0038820 A1
(43) Pub. Date: Feb. 11, 2016

(54) Programmable Electronic Sports Training System Utilizing Directional Indicator Cones

(71) Applicant: SMART Sports, LLC, Jacksonville, FL (US)

(72) Inventors: Abolaji Lateef Junaid, Jacksonville, FL (US); Abbi Junaid, Jacksonville, FL (US)

(21) Appl. No.: 14/807,557

(22) Filed: Jul. 23, 2015

Related U.S. Application Data
(60) Provisional application No. 62/028,313, filed on Jul. 23, 2014.

(51) Int. Cl. A63B 71/06; G09B 5/02

(52) U.S. Cl. CPC A63B 71/0622; G09B 5/02; A63B 2244/00; A63B 2071/065

(57) ABSTRACT

As described, the present invention provides a complete sports training system, including a computing device and directional cones. More particularly, the sports training system comprises a computing device that may be utilized in conjunction with directional cones, wherein the sports training system may develop training courses, collect training data, and provide training instructions.

### CROSS REFERENCE TO PRIOR RELATED APPLICATIONS

The present disclosure claims priority to U.S. Provisional Patent Application Ser. No. 62/028,313, entitled Programmable Electronic Sports Training System Utilizing Directional Indicator Cones, filed Jul. 23, 2014, the contents of which are relied upon and incorporated by reference.

### BACKGROUND OF THE INVENTION

1. Field of the Invention

The present invention relates to a complete sports training system, including a computing device and directional cones. More particularly, the sports training system comprises a computing device that may be utilized in conjunction with directional cones, wherein the sports training system may develop training courses, collect training data, and provide training instructions.

2. Discussion of the Related Art

Sports are a global pastime, with participants ranging from highly skilled professional athletes to preschoolers during recess. Despite this expansive range, the basic training techniques may be similar, and, consequently, the inefficiencies may also be similar.

Generally, once equipment is set up, a coach or trainer must explain the training exercise. Depending on the training needs of the class or team, a coach may have to explain multiple exercises to multiple groups or players. Cones may be used to develop a training course, but currently, cones are simply visual markers that indicate some change in action. As such, there exists a need to develop a more efficient and more complete sports training system.

### SUMMARY OF THE INVENTION

Accordingly, the present invention provides a comprehensive sports training system, including a computing device and directional cones. More particularly, the sports training system comprises a computing device that may be utilized in conjunction with directional cones, wherein the sports training system may develop training courses, collect training data, and provide training instructions.

The present disclosure describes a system of one or more computers that may be configured to perform particular operations or actions by virtue of having software, firmware, hardware, or a combination thereof installed on the system that in operation causes the system to perform the actions. One or more computer programs may be configured to perform particular operations or actions by virtue of including instructions that, when executed by data processing apparatus, cause the apparatus to perform the actions. One general aspect includes a network access device, such as a smartphone or tablet, for accessing a server in logical communication with a communications network along with executable software stored on the network access device and executable on demand or command. Implementations of the described techniques may include hardware, a method or process, or computer software on a computer-accessible medium.

The software operative with the network access device may cause the network access device to: receive training course information, where the training course information includes a path created with a series of directional cones. The network access device also includes transmitting the training course information to an external server. The network access device also includes presenting the training course information to a user. Other embodiments of this aspect include corresponding computer systems, apparatus, and computer programs recorded on one or more computer storage devices, each configured to perform the actions of the methods.

In some aspects, the directional cones may comprise a cone configured to be placed on a planar surface as a visual marker, where the visual marker indicates a point on the path; a directional indicator extending from the cone in a position generally parallel to the planar surface, where the directional indicator is configured to indicate a path direction. In some implementations, the directional cones may further comprise a stabilizing feature configured to stabilize the directional cone on the planar surface.

Implementations may include one or more of the following features. The network access device may be further caused to prompt the user to respond to the presented training course information, where an acceptance is indicative of interest or lack of interest in participating in the presented training course information. The network access device may be further caused to collect training data from participation of the user in the presented training course information.

In some aspects, each directional cone of the series of directional cones may further include a directional cone position device. The directional cone position device may be configured to transmit data to the network access device. The network access device may be further caused to recognize when a user passes each directional cone. The directional cone position device may include a motion detector, where the recognition is based on motion detection. In some aspects, the network access device may be further caused to verify positions of the series of directional cones aligning with the path of the series of directional cones according to the training course information.

The programmable electronic training system further including a portable user tracking device configured to be worn or carried by the user, where the recognition is based on one or both user position data transmitted to one or both the directional cone position device or the network access device and directional cone position data transmitted to one or both the portable user tracking device of the network access device. In some embodiments, the recognition may be based on proximity of the portable user tracking device to the directional cones. One or both the user tracking device and the directional cone position device may include global positioning systems, where the recognition may be based on a relation between the user position data and the directional cone position data transmitted from the global positioning systems. The programmable electronic training system may comprise a portable user tracking device, which may be integrated with the network access device or may comprise a secondary communication device, such as, for example, an active communication device (i.e. fitness band) or a passive communication device (i.e. RFID chip).

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1A illustrates an exemplary embodiment of a collapsible directional cone device.

FIG. 1B illustrates an exemplary embodiment of a collapsible directional cone device.

FIG. 1C illustrates an exemplary embodiment of a collapsible directional cone device.

FIG. 1D illustrates an exemplary directional cone device as fitted with an exemplary cone type.

FIG. 1E illustrates an exemplary directional cone device as fitted with an alternate exemplary cone type.

FIG. 1F illustrates a top down view of an exemplary directional cone device.

FIG. 2A illustrates an exemplary embodiment of a directional cone.

FIG. 2B illustrates an exemplary embodiment of a directional cone.

FIG. 2C illustrates an alternate exemplary embodiment of a directional cone.

FIG. 2D illustrates an alternate exemplary embodiment of a directional cone.

FIG. 2E illustrates an alternate exemplary embodiment of a directional cone.

FIG. 3A illustrates a top view of an exemplary directional cone.

FIG. 3B illustrates a top view of an exemplary directional cone.

FIG. 3C illustrates a top view of an exemplary directional cone.

FIG. 3D illustrates a top view of an exemplary directional cone.

FIG. 4A illustrates a top view of an alternative exemplary embodiment of directional cone.

FIG. 4B illustrates a top view of an alternative exemplary embodiment of directional cone.

FIG. 4C illustrates a top view of an alternative exemplary embodiment of directional cone.

FIG. 5A illustrates an exemplary embodiment of supplemental directional indicators.

FIG. 5B illustrates an exemplary embodiment of supplemental directional indicators.

FIG. 5C illustrates an exemplary embodiment of supplemental directional indicators.

FIG. 5D illustrates an exemplary embodiment of supplemental directional indicators.

FIG. 5E illustrates an exemplary embodiment of supplemental directional indicators.

FIG. 5F illustrates an exemplary embodiment of supplemental directional indicators.

FIG. 6A illustrates an alternate exemplary embodiment of a directional cone.

FIG. 6B illustrates an alternate exemplary embodiment of a directional cone.

FIG. 6C illustrates an alternate exemplary embodiment of a directional cone.

FIG. 7 illustrates an exemplary embodiment of a training course utilizing various embodiments of directional cones, aim-training gates, alphanumeric component cones, and supplemental directional indicators.

FIG. 8 illustrates an exemplary graphical user interface, according to some embodiments of the present disclosure.

FIG. 9 illustrates an exemplary processing and interface system, according to some embodiments of the present disclosure.

FIG. 10 illustrates a block diagram of an embodiment of a mobile device according to some embodiments of the present disclosure.

FIG. 11 illustrates an exemplary controller according to some embodiments of the present disclosure.

### DETAILED DESCRIPTION OF THE INVENTION

### Glossary

Cone: as used herein, cone refers to a freestanding object that may be used as a visual marker when placed on a surface, including, for example, a sports field or court. A cone may comprise a traditional conical shape, but other shapes should be considered as part of the inventive art, including, for example, a pyramid or cube.

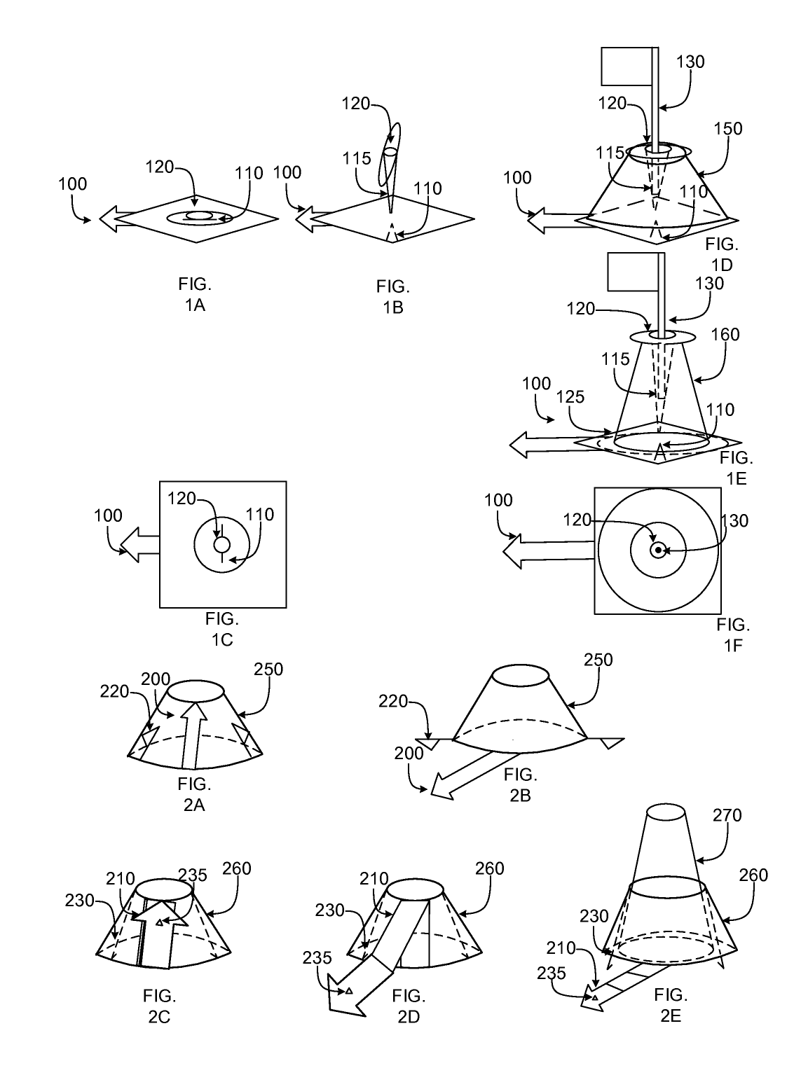

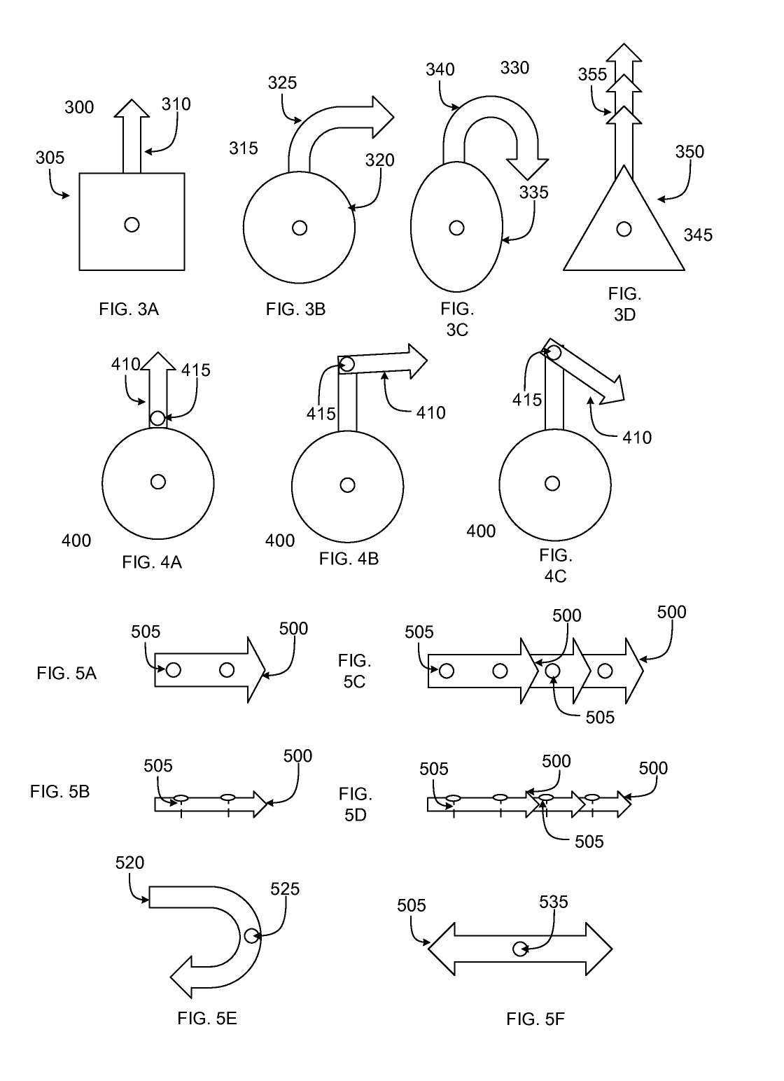

Referring now to FIGS. 1A-1C, an exemplary embodiment of a collapsible directional cone device is illustrated. Referring to FIG. 1A, when fully collapsed, the directional cone device may be essentially a stack of planar components, similar to a stack of beverage coaster. As illustrated in a top view in FIG. 1C, the collapsible directional cone device may comprise concentric circles with a rectangular base with a directional indicator 100 extending from said circles. In some examples, such as illustrated in FIGS. 3A-3D, the shapes of the bases may be varied, which may emphasize the directional or speed indication of the directional cone.

In some aspects, the directional indicator 100 may comprise a writeable surface, wherein a user or trainer may add training instructions for reference, such as “squats” or “lunges,” for example. The writeable surface may comprise a chalkboard or a white board, wherein the writing may be manual; a digital display, wherein the writing may be electronically transmitted, such as wirelessly from a handheld device; or a magnetic board, wherein the instructions may be attached to the surface.

In some exemplary embodiments, the directional cone device may comprise a stabilizing feature 110, which may be collapsible or flattened when not in use or when additional stability may not be necessary, for example. Referring to FIG. 1B, when the directional cone device is expanded, a pocket 115 may be formed that may be capable of securing a marker, such as a flag. In some exemplary embodiments, the top fitting 120 may pivot to fit through the top opening of a cone. Alternatively, not shown, the top fitting 120 may be pliable, wherein a user may pinch or bend the top fitting 120 and pull it through the top opening of a cone.

In some embodiments, a collapsible directional cone device may fit a range of cone types. For example, referring to FIGS. 1C-1F, a directional cone device is illustrated as fitted with two different cone types. As shown in FIG. 1D, the cone 150 may comprise a short, relatively flat, sports cone. Alternatively, as shown in FIG. 1E, the cone 160 may comprise a more standard cone, including, for example, a safety cone. In some examples, the top fitting 120 may be the same size or larger than the top opening of the cone, wherein the top fitting 120 may rest over the top opening of the cone or wherein the top fitting 120 securely fits within the top opening. Similarly, the bottom fitting 125 may be the same size or larger than the bottom opening of the cone. In such embodiments, the bottom fitting 125 and the directional indicator 100 may lay parallel to the ground.

In some exemplary embodiments, the top opening 120 may comprise a pocket 115, which may securely hold an identifying marker 130, including, for example, a numbered flag or a color button. In some examples, the identifying marker 130 may allow a coach to assign course paths to separate individuals, such as by athletic capability or training needs. In other examples, such as described in FIG. 5F, a numbered identifying marker 130 may indicate how many times a participant should complete an action, such as shooting at an aim-training gate or running the entire course.

Referring now to FIGS. 2A and 2B, an exemplary embodiment of a directional cone 250 is illustrated in two settings. In some exemplary embodiments, a directional cone 250 may comprise a directional indicator 200 and a stabilizing feature 220. The directional indicator 200 may be static, such as illustrated in FIGS. 3A-3D, or may be adjustable, such as illustrated in FIGS. 4A-4C. In some exemplary embodiments, one or both of the directional indicator 200 and the stabilizing feature 220 may be folded to lay flush against the directional cone 250 when the directional cone 250 may be stored or when direction may not be necessary. Such embodiments may allow multiple directional cones 250 to be compactly stacked.

In some examples, the directional indicator 200 may be independent from the stabilizing feature 220. Whereas in other examples, not shown, the directional indicator may further comprise a stabilizing feature, similar to the stabilizing feature 220 shown. The stabilizing feature 220 may comprise a protrusion capable of securing the position of the directional cone 250. In some exemplary embodiments, the stabilizing feature 220 may be pressed into the soil, such as on a sports field. Alternatively, the stabilizing feature 220 may be weighted to limit movement where the ground may not be easily penetrated, such as in a gym or a tennis court. Other stabilizing methods may be practical and are well within the inventive art described herein.

Referring now to FIGS. 2C-2E, an alternate exemplary embodiment of a directional cone 260 is illustrated in three settings. In some exemplary embodiments, similar to the example illustrated in FIGS. 2A and 2B, the directional cone 260 may comprise a directional indicator 210 and a stabilizing feature 230. In contrast to FIG. 2A, the directional indicator 210 and the stabilizing feature 230 may be foldable, allowing for a longer directional indicator 210. In some such embodiments, the stabilizing feature 260 may be retractable, wherein an extension of the stabilizing feature 230 into the ground may limit the movement of the directional cone 260.

As illustrated in FIG. 2C, the foldable directional indicator 210 may be collapsible, wherein when fully collapsed, the directional indicator 210 may lay flat or flush against the surface of the directional cone 260. In some exemplary embodiments, the directional indicator 210 may further comprise a securing feature 235, which may secure the collapsed position of directional indicator 210. As illustrated in FIG. 2D, the directional indicator 210 may be unfolded at living hinges, wherein the directional indicator 210 may comprise the same material throughout. Alternatively, not shown, the segments of the directional indicator 210 may be connected by a separate hinging mechanism.

Referring now to FIG. 2E, an exemplary embodiment of a directional cone 260 with a fully extended directional indicator 210 is illustrated. In some examples, the securing feature 235 may secure the fully extended position of the directional indicator 210, for example, by pinning the tip of the directional indicator 210 into the ground. In some exemplary embodiments, as illustrated in FIG. 2E, the directional cone 260 may be fitted over other cones 270 without directional indicators. In some such examples, the directional cone 260 may comprise a semi-rigid or expandable material, such as neoprene or rubber. In still further examples, the directional cone 260 may be reversible, wherein the directional cone 260 may be flipped inside out. Such embodiments may allow for two colors, for example, red and green, which may alternatively indicate the beginning or end of a training course. Such embodiments may enable the directional indicator 210 to point in two directions.

Referring now to FIGS. 3A-3D, top views of exemplary directional cones 300, 315, 330, 345 are illustrated, wherein the directional indicators 310, 325, 340, 355 and the bases 305, 320, 335, 350 are varied but fixed in each of the figures. In some exemplary embodiments, such as illustrated in FIG. 3A, the directional indicator 310 may direct a runner, athlete, or sport participant to move straight when passing the directional cone 300. In such examples, a square or rectangular cone base 305 combined with straight indicator 310 may prompt an athlete to make a sharp turn around the right angles of the rectangular base 305. Accordingly, exemplary embodiments with a rectangular base 305 and a straight indicator 310 may be multi-purpose.

In other exemplary embodiments, as illustrated in FIG. 3B, the directional indicator 325 may direct the participant to move right when passing the directional cone 315. In some examples, a circular base 320 in combination with a curved indicator 325 may prompt a more natural or gradual turn than the embodiment illustrated in FIG. 3A, for example.

As another example, as illustrated in FIG. 3C, the directional indicator 340 may direct the participant to move around the cone 330 and switch directions, essentially making a u-turn. An elliptical base 335 may clarify the turning point in the u-turn and may be more effective than a circular base 320, such as illustrated in FIG. 3B, which may be confused with a left or right turn, even when combined with a u-turn indicator 340.

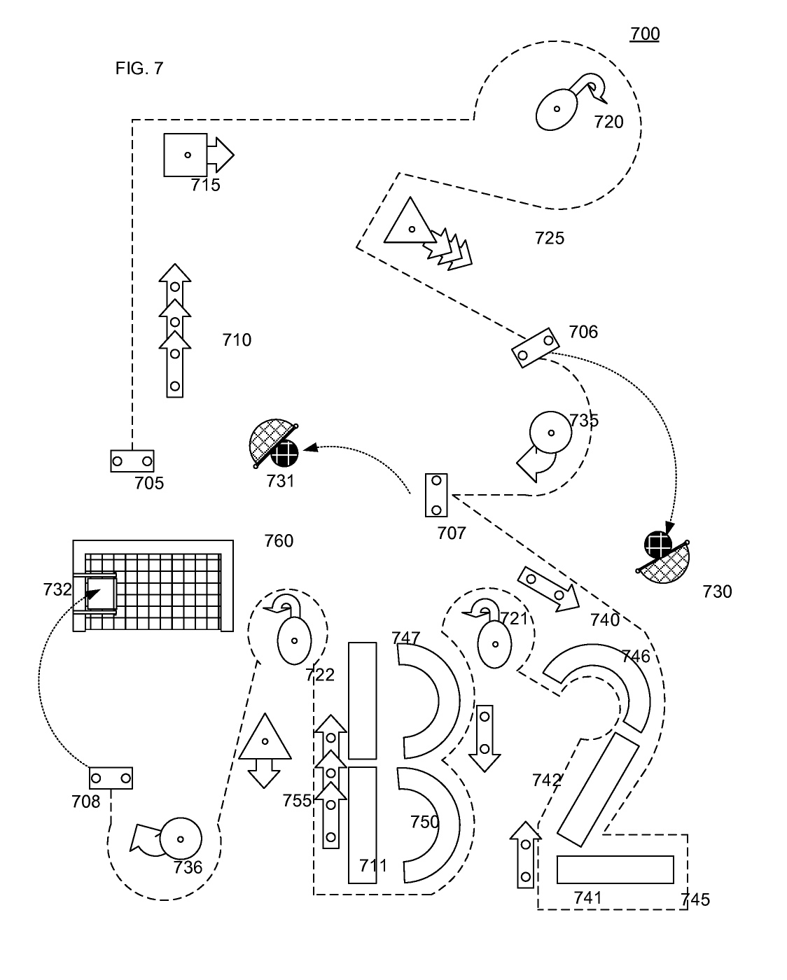

In another example, as shown in FIG. 3D, the directional indicator 355 may indicate direction and relative speed. Multiple straight arrows in the directional indicator 355 may prompt the participant to sprint or run faster past the directional cone 345, whereas a single straight arrow 310 may prompt the participant to maintain a speed or slow down. Direction cones 345 that may indicate a change in speed may comprise a triangular base 350. For example, as illustrated, the triangular base 350 may point in the same direction as the direction indicator 355, which may emphasize an increase in speed. In contrast, the triangular base 350 may point in the opposite direction of the direction indicator 355 to emphasize a decrease in speed, such as illustrated in FIG. 7.

Referring now to FIGS. 4A-4C, top views of an alternative exemplary embodiment of directional cones 400 are illustrated, wherein the directional indicator 410 may be adjustable. In some exemplary embodiments, the directional indicator 410 may comprise a pivot point 415, which may allow a coach, trainer, or gym teacher to change the route without having to replace the directional cone 400. For example, as shown in FIG. 4A, the directional indicator 410 may guide the athlete to run straight when passing the directional cone 400. Utilizing the same or similar directional cone 400, a coach may change the route by adjusting the directional indicator 410 at its pivot point 415. For example, as shown in FIG. 4B, the directional indicator may point right, similar to the embodiment illustrated in FIG. 3B. In some exemplary embodiments, the directional indicator 410 may be extended to allow for clearer route guidance. In some exemplary embodiments, the pivot point 415 may allow the directional indicator 410 to rotate in any of the 360° around said pivot point 415. For example, as shown in FIG. 4C, the directional indicator 410 may guide the athlete to run back around the directional cone 400, similar to the u-turn directional indicator 330 shown in FIG. 3C.

Referring now to FIGS. 5A-5F, exemplary embodiments of supplemental directional indicators 500, 520, 530 are illustrated. In some exemplary embodiments, non-cone directional guidance may be helpful to clarify the course between cones. Such an embodiment may allow a coach or trainer to expand the route area without requiring extensive explanation.

In some examples, such as illustrated in FIG. 5A in top view and FIG. 5B in side view, a supplemental indicator 500 may comprise a straight line with one terminal arrow, which may prompt a runner to continue in a specific direction. The supplemental indicator 500 may further comprise one or more stabilizers 505, including, for example, a removable stake through a hole in the supplemental indicator 500 or a retractable stake embedded on the surface of the supplemental indicator 500. In some examples, such as illustrated in FIG. 5C in top view and FIG. 5D in side view, multiple supplemental indicators 500 may be layered in a staggered formation, wherein the combination may prompt an increase in speed. In such embodiments, the stabilizers 505 may be overlapped to secure the stacked and staggered formation.

In some exemplary embodiments, such as illustrated in FIG. 5E, the supplemental indicator 520 may comprise a curved arrow with a stabilizer 525. As another example, the supplemental indicator 530 may comprise a straight line with an arrow on both terminals, such as illustrated in FIG. 5F. Such an embodiment may prompt a participant to choose between paths or it may prompt a participant to run back and forth, wherein the prompt may depend on the construction of the course. In some such embodiments, a number indicator, such as described and illustrated in FIG. 1, may be placed as the stabilizer 535, for example. The number indicator may direct a participant to run back and forth for a specified number of times.

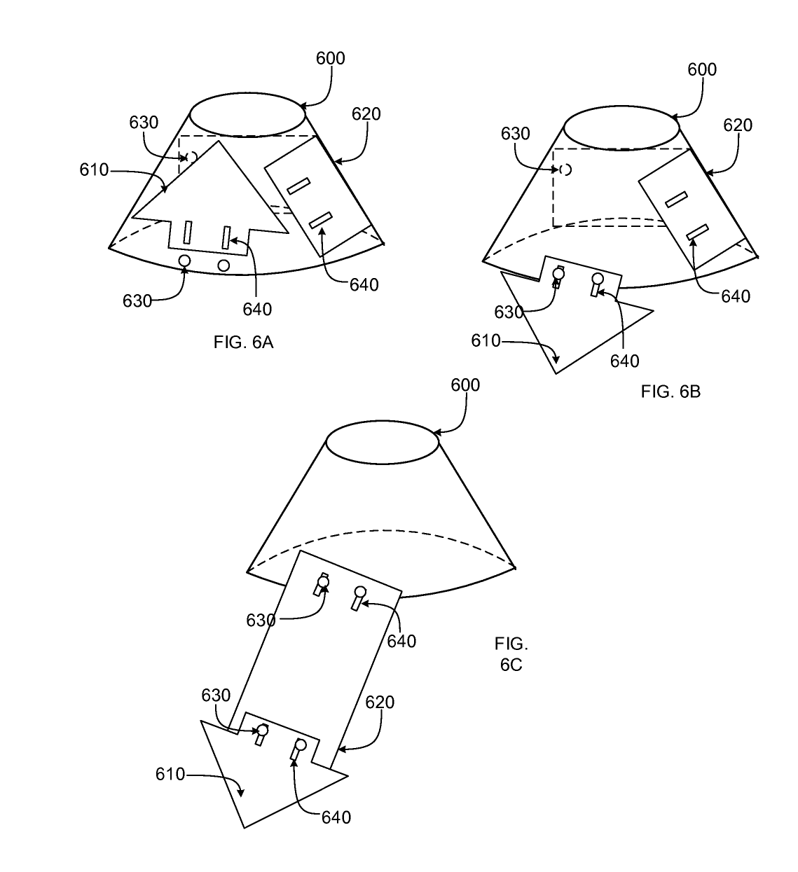

Referring now to FIGS. 6A-6C, an alternate exemplary embodiment of a directional cone 600 is illustrated, wherein a directional cone 600 may comprise detachable directional components 610, 620. As shown in FIG. 6A, the directional components 610, 620 may be included, held, or contained on or within the directional cone 600. For example, the directional components 610, 620 may adhere to the surface of the directional cone 600 utilizing magnets, Velcro, or static cling. Alternatively, the directional cone 600 may comprise fitted recesses or pockets configured to hold the directional components 610, 620. In some embodiments, the directional cone 600 may comprise multiple extenders 620 which may allow for a broader range of directional indication lengths and directions.

In some examples, the directional components may comprise a direction arrow 610 and an extender 620. The directional cone 600 may further comprise attaching features 630, wherein one or both the direction arrow 610 or extender 620 may be connected to the directional cone 600 by the attaching feature 630. In some embodiments, the direction arrow 600 may further comprise a complementary attaching feature 640, and the extender 620 may further comprise one or both attaching feature 630 or complementary attaching features 640 such as at opposite ends. As a few illustrative examples, the attaching feature 630 and the complementary attaching feature 640 may comprise a button and slit, Velcro strips, snaps, or a hook and eyelet. When directional indication may not be necessary with the directional cone 600, the direction arrow 610 and the extender 620 may be used as a supplemental direction indicator, such as illustrated and described with FIGS. 5A-5F.

Referring now to FIG. 6B, an exemplary embodiment of a directional cone 600 is illustrated with a non-extended directional indication. In small spaces or short courses, it may be practical to limit the size of the directional indication. For example, a course set up for small children may provide a very short distance between cones, which may make an extended directional indication unnecessary or confusing. In some examples, the direction arrow 610 may be independently extended from the directional cone 600 without requiring the use of the extender 620, which may remain on the directional cone 600. The complementary attaching feature 640 on the direction arrow 610 may be secured to the attaching feature 630 on the directional cone 600. In some embodiments, the extender 620 may be used as an action stop marker in a training course, such as illustrated in FIG. 7.

Referring now to FIG. 6C, an exemplary embodiment of a directional cone 600 is illustrated with a fully extended directional indication. In some situations, the direction arrow 610 alone may not be sufficient to clearly indicate a direction. For example, the direction arrow 610 may be easily obscured in a grassy field or may be too small to be visible in a larger training course. In some exemplary embodiments, the complementary attaching feature 640 of the extender 620 may be connected to the attaching feature 630 on the directional cone 600, and the complementary attaching feature 640 on the direction arrow 610 may be connected to the attaching feature 630 on the extender 620.

In some examples, the attaching features 630 and the complementary attaching features 640 may allow one or both the direction arrow 610 or extender 620 to pivot, which may allow for a broad range of directional indication, without requiring multiple direction arrows 610 or extenders 620. In other embodiments, the extenders 620 may be varied, such as, a straight line, a curved line, or a u-shaped line. Still further examples may include multiple direction arrows 610 that may allow for different directional indications.

Referring now to FIG. 7, an exemplary embodiment of a training course utilizing various embodiments of directional cones, aim-training gates, alphanumeric component cones, and supplemental directional indicators is illustrated. In some exemplary embodiments, a coach or trainer may design a complex training course for players or athletes to follow without requiring extensive explanation. The training path 700 may be self-explanatory based on the directional, speed, and action indicators that may be laid out for the training course. The course shown in FIG. 7 is an illustrative example, but other course variations with different equipment combinations may be practical and are well within the inventive art described herein.

In some exemplary embodiments, the start point of the course may be marked with an extender 705. The supplemental directional indicators 710 may be layered to prompt a player to sprint to the next indication. A directional cone 715 with a rectangular base may prompt the player to make a hard right. The player may then follow that training path 700 until the next directional cone 720, which may prompt the player to run around the directional cone 720 in a u-turn around an elliptical base. The next directional cone 725 with a triangular base may prompt the player to make a sharp turn and sprint to the next prompt.

The training path 700 may be interrupted with an action stop 706, such as marked with an extender, in line with a training gate 730, wherein the player may be prompted to kick or throw a ball into the training gate 730. In some exemplary embodiments, a player may run the training path 700 while dribbling a ball so that the player may already have a ball to kick into the training gate 730. In some other examples, a ball or balls may be stationed at the action stops 706. The player may proceed from the action stop 706 once successful or after a limited number of attempts, such as limited by the supply of balls at the action stop 706.

The player may then proceed to the next directional cone 735, which may prompt the player to turn right around the directional cone 735. The training path 700 may then be interrupted by a second action stop 707, such as marked with an extender. The player may be prompted to shoot or throw at a second training gate 731. A supplemental directional indicator 740 may direct the player to approach the alphanumeric component cones 746, 747.

As an illustrative example, the alphanumeric component cones 746, 747 are shown in a “2” arrangement 745 and a “B” arrangement 750. The player may run around the “2” arrangement 745 following the supplemental directional indicator 741 providing general guidance how to maneuver around the “2” arrangement 745. A u-turn directional cone 721 with an elliptical base may be placed between the “2” arrangement 745 and the “B” arrangement 750, wherein the directional cone 721 may direct the player how to engage the “B” arrangement 750.

In some exemplary embodiments, a supplemental directional indicator 742 may confirm the direction of the training path 700 around the “B” arrangement 750. Layered supplemental directional indicators 711 may be placed near the straight alphanumeric component cones 747, wherein the supplemental directional indicators 711 may prompt the player to sprint the straightaway. A u-turn directional cone 722 with an elliptical base may be placed where the training path 700 reaches the end of the “B” arrangement. Another directional cone 755 with an inverted triangular base may direct the player to slow down before following the next right-turn directional cone 736, which may then direct the player to a final action stop 708. At the final action stop 708, a player may be prompted to kick, throw, or hit a ball at an aim-training gate 732 placed on a goal frame 760.

In other exemplary training courses, multiple players may participate in a singular course, for example, in a relay fashion. As an example, a capture net may not be attached to the training gates, and a second player may resume the training path after a first player has successfully passed a ball through the training gate. Such exemplary embodiments may engage the players as a team, which may add a benefit of teamwork training to the personal skill training

In some embodiments, the directional cones may be color coded, wherein each direction may be associated with a unique color or marking For example, left turns may be blue, right turns may be white, and u turns may be yellow. The training system may present the course according to those colors and further specify that the course requires three blue, two white, and two yellow directional cones or indicators, where the indicators may be detachable.

In some embodiments, a user may purchase training sets, such as for weight loss or soccer agility. In some aspects, a user may subscribe to a particular group, trainer, or coach, wherein a user may have access to courses input by the group, trainer, or coach. For example, a user may want personal training from a celebrity trainer, so, the user may subscribe to that celebrity trainer's courses. Alternatively, a child may be part of a local soccer team, and the coach or club may provide weekly courses for the child to practice.

In some embodiments, the directional cone may further comprise a tracking chip, such as a bluetooth or radio frequency identification tag, wherein a smartphone or other device may recognize when a user has successfully passed a directional cone. In some aspects, the device may track the speed of the user through the course. A trackable chip may also allow the user to confirm that the course is set up properly or may allow the device to track the progress of the user's speed, agility, and endurance. In some aspects, the training system may allow a user to run through a training course wearing or holding a mobile device, such as a smartphone. The training system may utilize an accelerometer, such as may be built into the device, to detect motion and movement through the training course.

In some aspects, the training system may prompt a user to stand at a particular point, such as at the start cone, and capture an image of the training course. The training system may be configured to evaluate relative distances and proportions from the image, wherein the evaluation may verify whether the user has appropriately set up the training course. In some aspects, the training system may prompt the user to place directional cones 2 and 3 further apart, for example. Alternatively, the training system may use the distance information to more accurately evaluate the user's performance.

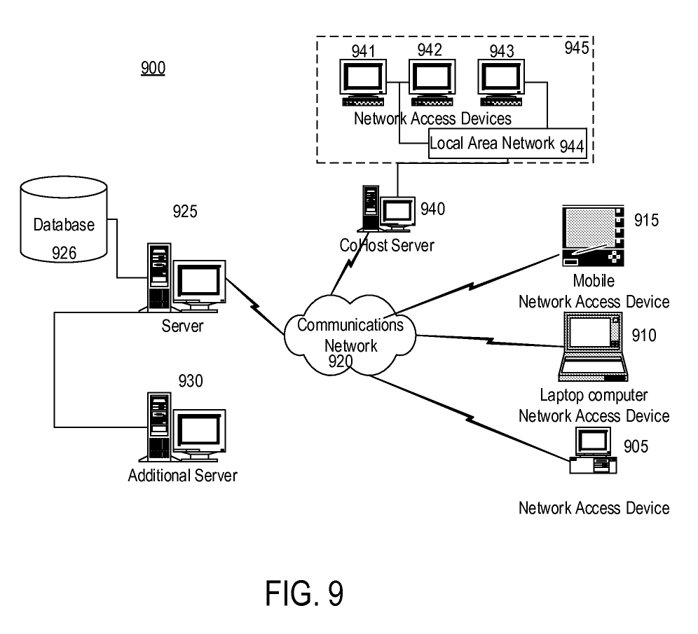

In some embodiments, the training system may further comprise a server, such as described and illustrated in FIG. 9, which may aggregate and organize training and course data from users. In some such aspects, the training system may offer statistics to users, wherein the statistics comprise historical data associated with one or more users. For example, a college scout may want to verify the abilities of some prospects and may research their times for certain courses. A user may be able to compare his abilities to other users who ran a particular course. In some aspects, the user may be able to further specify that he wants to compare his results only to male users between the ages 17-21.

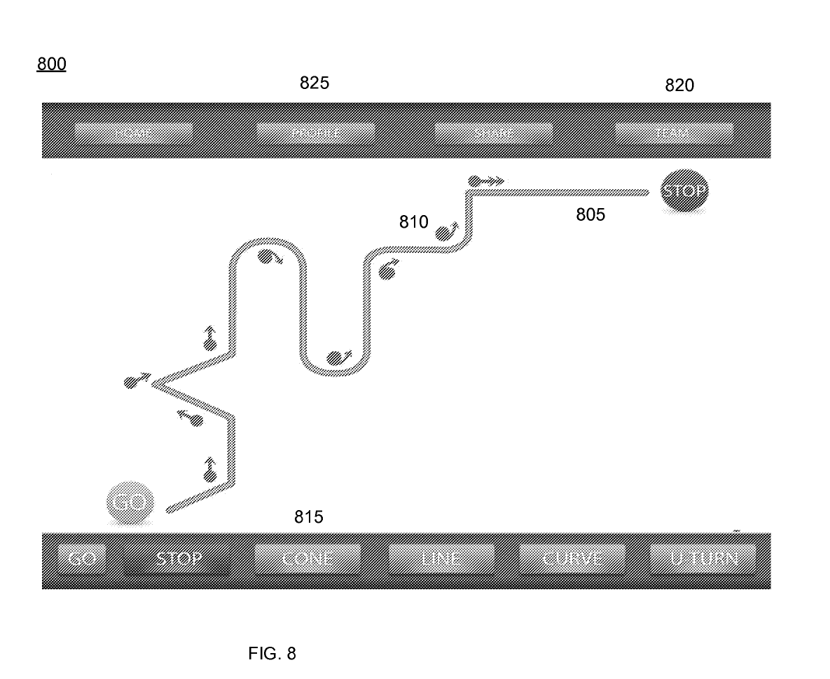

Referring now to FIG. 8, an exemplary graphical user interface (GUI) 800 is illustrated. In some embodiments, the GUI 800 may provide a visual representation of a training course 805. A user may be prompted to select or accept the training course 805. The training course 805 may comprise a series of directional cone icons 810 indicating how the user should set up their directional cones. The directional cone icons 810 may indicate the relative positions and the direction types, which may allow a user to precisely set up the training course 805.

Where a user may prefer to browse other options, the user may be able to cycle through training courses 805. In some aspects, the user may sort the training courses 805, such as by ability level, training goals, length of training, sport, or trainer. In some embodiments, a user may view training courses 805 by popularity or user rating. In still further aspects, the user may sort training courses 805 by collected training statistics, such as by amount of collected training data, average user ability level associated with the collected training data, amount of collected training data that may be available to or reviewed by scouts of professional sports team.

In some embodiments, the GUI 800 may allow a trainer or user to develop training courses 805 directly through the GUI 800. The GUI 800 may comprise cone selection icons 815, wherein a trainer or user may click on the cone selection icons 815 to add a directional cone icon 810 to the training course 805. The user or trainer may then drag the directional cone icon 810 around the GUI 800 to set up the training course.

In some embodiments, the GUI 800 may be customized based on the user, which may be integrated into a profile, which may be accessed through a profile icon 825. A user profile may store preferences, goals, and prior training courses, wherein the user profile may allow for an adaptive GUI 800 and training courses 805. For example, an adult user who may be striving for weight loss may prefer to track weigh-ins and diet, along with the training course performances. Alternatively, the user may be a child, and the parent may want to view the team schedule with practices and games. As another example, the user may be an athlete trying to make a professional sports team. In such an example, the user may want to view performance data of his competitors in comparison to his own for a particular training course.

In some embodiments, a trainer or coach may develop a course and input course instructions. The trainer may specify the necessary directional cones and the exercises to be performed at each station. In some aspects, the trainer may create the course by drawing the route and assigning exercises to certain portions. The training system may identify the necessary directional cones based on the layout of the course. The user may be presented with the course layout and the number of each directional cones needed to complete the course.

In some embodiments, the training system may indicate the maximum required directional cones for a course set, wherein a user may be able to sort course sets by directional cone requirements. A course set may comprise a collection of courses pertaining to a particular trainer, sport, endurance level, or other similar categorizations. For example, a user may own five directional cones with two yellow indicators, three white indicators, and two blue indicators. Accordingly, the user may prefer course sets that do not require more than he may already own. Alternatively, the user may want to know how many more directional cones he should buy to be able to train on a particular course set.

Referring now to FIG. 9, an exemplary processing and interface system 900 is illustrated. In some aspects, access devices 915, 910, 905, such as a mobile device 915 or laptop computer 910 may be able to communicate with an external server 925 though a communications network 920. The external server 925 may be in logical communication with a database 926, which may comprise data related to identification information, associated user or trainer profile information, and training courses. In some examples, the server 925 may be in logical communication with an additional server 930, which may comprise supplemental processing capabilities, such as, for example, developing an adaptive GUI or training courses based on evolving profile attributes.

In some embodiments, the access devices 915, 910, 905 may comprise a portable user tracking device or may be in communication with a secondary communication device comprising a portable user tracking device, such as a wearable RFID chip or fitness band. The portable user tracking device may provide positional data of the user. In some embodiments, the positional data may be acquired from a global positioning system (GPS) in the user tracking device. In some aspects, the directional cones may also comprise a GPS, and the GPS data from the portable user tracking device may be compared to the GPS data from the directional cones, wherein the comparison may indicate the progress, efficiency, and other participation data of the user with the training course.

In some aspects, the server 925 and access devices 905, 910, 915 may be able to communicate with a cohost server 940 through a communications network 920. The cohost server 940 may be in logical communication with an internal network 945 comprising network access devices 941, 942, 943 and a local area network 944. For example, the cohost server 940 may comprise a payment service, such as PayPal or a social network, such as Facebook or a fitness tracking site.

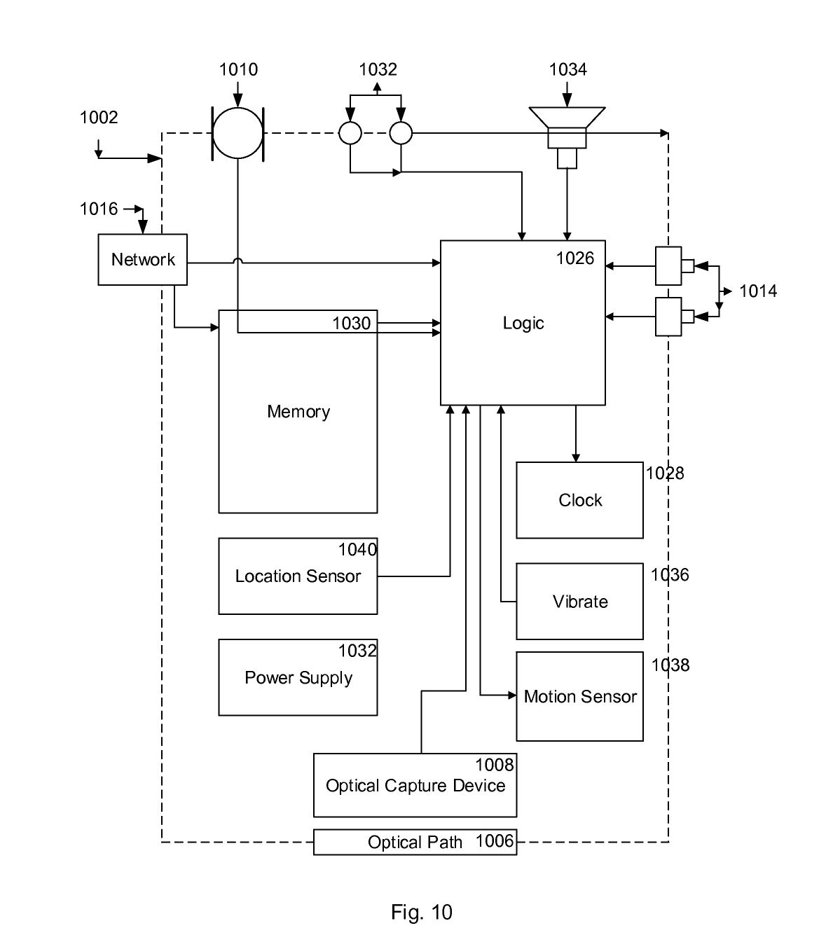

FIG. 10 is a block diagram of an embodiment of a mobile device 1002. The mobile device 1002 comprises an optical capture device 1008 to capture an image and convert it to machine-compatible data, and an optical path 1006, typically a lens, an aperture, or an image conduit to convey the image from the rendered document to the optical capture device 1008. The optical capture device 1008 may incorporate a Charge-Coupled Device (CCD), a Complementary Metal Oxide Semiconductor (CMOS) imaging device, or an optical sensor of another type.

A microphone 1010 and associated circuitry may convert the sound of the environment, including spoken words, into machine-compatible signals. Input facilities 1014 exist in the form of buttons, scroll-wheels, or other tactile sensors such as touch-pads. In some embodiments, input facilities 1014 may include a touchscreen display.

Visual feedback 1032 to the user is possible through a visual display, touchscreen display, or indicator lights. Audible feedback 1034 may come from a loudspeaker or other audio transducer. Tactile feedback may come from a vibrate module 1036.

A motion sensor 1038 and associated circuity convert the motion of the mobile device 1002 into machine-compatible signals. The motion sensor 1038 may comprise an accelerometer which may be used to sense measurable physical acceleration, orientation, vibration, and other movements. In some embodiments the motion sensor 1038 may include a gyroscope or other device to sense different motions.

A location sensor 1040 and associated circuitry may be used to determine the location of the device. The location sensor 1040 may detect Global Position System (GPS) radio signals from satellites or may also use assisted GPS where the mobile device may use a cellular network to decrease the time necessary to determine location. In some embodiments, the location sensor 1040 may use radio waves to determine the distance from known radio sources such as cellular towers to determine the location of the mobile device 1002. In some embodiments these radio signals may be used in addition to GPS.

The mobile device 1002 comprises logic 1026 to interact with the various other components, possibly processing the received signals into different formats and/or interpretations. Logic 1026 may be operable to read and write data and program instructions stored in associated storage 1030 such as RAM, ROM, flash, or other suitable memory. It may read a time signal from the clock unit 1028. In some embodiments, the mobile device 1002 may have an on-board power supply 1032. In other embodiments, the mobile device 1002 may be powered from a tethered connection to another device, such as a Universal Serial Bus (USB) connection.

The mobile device 1002 also includes a network interface 1016 to communicate data to a network and/or an associated computing device. Network interface 1016 may provide two-way data communication. For example, network interface 1016 may operate according to the internet protocol. As another example, network interface 1016 may be a local area network (LAN) card allowing a data communication connection to a compatible LAN. As another example, network interface 1016 may be a cellular antennae and associated circuitry which may allow the mobile device to communicate over standard wireless data communication networks. In some implementations, network interface 1016 may include a Universal Serial Bus (USB) to supply power or transmit data. In some embodiments other wireless links may also be implemented.

As an example of one use of mobile device 1002, a reader may scan some text from a newspaper article with mobile device 1002. The text is scanned as a bit-mapped image via the optical capture device 1008. Logic 1026 causes the bit-mapped image to be stored in memory 1030 with an associated time-stamp read from the clock unit 1028. Logic 1026 may also perform optical character recognition (OCR) or other post-scan processing on the bit-mapped image to convert it to text. Logic 1026 may optionally extract a signature from the image, for example, by performing a convolution-like process to locate repeating occurrences of characters, symbols, or objects, and determine the distance or number of other characters, symbols, or objects between these repeated elements. The reader may then upload the bit-mapped image (or text or other signature, if post-scan processing has been performed by logic 1026) to an associated computer via network interface 1016.

As an example of another use of mobile device 1002, a reader may capture some text from an article as an audio file by using microphone 1010 as an acoustic capture port. Logic 1026 causes audio file to be stored in memory 1028. Logic 1026 may also perform voice recognition or other post-scan processing on the audio file to convert it to text. As above, the reader may then upload the audio file (or text produced by post-scan processing performed by logic 1026) to an associated computer via network interface 1016.

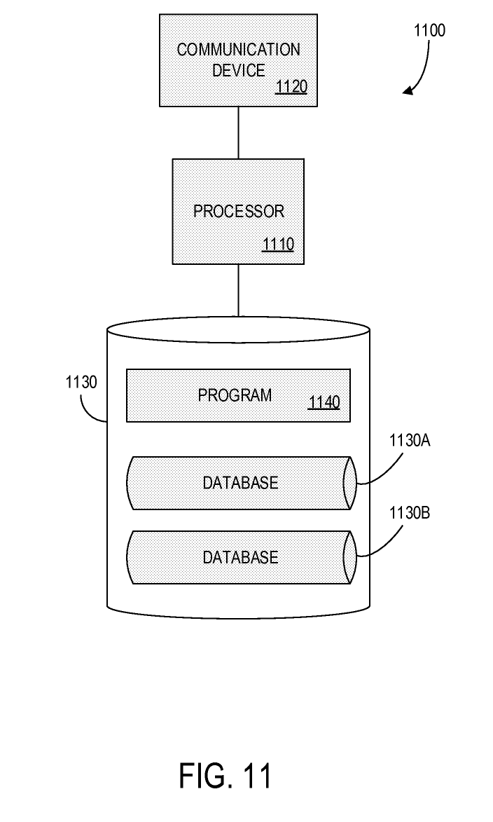

FIG. 11 illustrates a controller 1100 that may be embodied in one or more of the above listed devices and utilized to implement some embodiments of the present invention. The controller 1100 comprises a processor unit 1110, such as one or more processors, coupled to a communication device 1120 configured to communicate via a communication network (not shown in FIG. 11). The communication device 1120 may be used to communicate, for example, with one or more online devices, such as a personal computer, laptop, or a handheld device.

The processor 1110 is also in communication with a storage device 1130. The storage device 1130 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 1130 can store a program 1140 for controlling the processor 1110. The processor 1110 performs instructions of the program 1140 and thereby operates in accordance with the present invention. The processor 1110 may also cause the communication device 1120 to transmit information, including, in some instances, control commands to operate apparatus to implement the processes described above. The storage device 1130 can additionally store related data in a database 1130A and database 1130B, as needed.

Although shown and described in what is believed to be the most practical and preferred embodiments, it may be apparent that departures from specific designs and methods described and shown will suggest themselves to those skilled in the art and may be used without departing from the spirit and scope of the invention, including uses beyond sports training, such as physical therapy or traffic direction. The present invention is not restricted to the particular constructions described and illustrated, but should be constructed to cohere with all modifications that may fall within the scope of the appended claims.

1. A programmable electronic training system capable of facilitating training utilizing a plurality of directional cones, wherein the programmable electronic training system comprises:
a network access device for accessing a server in logical communication with a communications network; and
executable software stored on the network access device and executable on demand, the software operative with the network access device to cause the network access device to:
receive training course information, wherein the training course information comprises a path created with a series of directional cones, wherein each directional cone in the series of directional cones comprises:
a cone configured to be placed on a planar surface as a visual marker, wherein the visual marker indicates a point on the path;
a directional indicator extending from the cone in a position generally parallel to the planar surface, wherein the directional indicator is configured to indicate a path direction;
transmit the training course information to an external server;
present the training course information to a user.

2. The programmable electronic training system of claim 1, wherein the network access device is further caused to:
prompt the user to respond to the presented training course information, wherein an acceptance is indicative of interest or lack of interest in participating in the presented training course information.

3. The programmable electronic training system of claim 1, wherein the network access device is further caused to collect training data from participation of the user in the presented training course information.

4. The programmable electronic training system of claim 1, wherein the network access device comprises a smartphone.

5. The programmable electronic training system of claim 1, wherein the network access device comprises a tablet.

6. The programmable electronic training system of claim 3, wherein each directional cone of the series of directional cones further comprises a directional cone position device.

7. The programmable electronic training system of claim 6, wherein the directional cone position device is configured to transmit data to the network access device.

8. The programmable electronic training system of claim 7, wherein the network access device is further caused to recognize when a user passes each directional cone.

9. The programmable electronic training system of claim 8, wherein the directional cone position device comprises a motion detector, wherein the recognition is based on a motion detection.

10. The programmable electronic training system of claim 7, further comprising a portable user tracking device configured to be worn or carried by the user, wherein the recognition is based on one or both user position data transmitted to one or both the directional cone position device or the network access device and directional cone position data transmitted to one or both the portable user tracking device of the network access device.

11. The programmable electronic training system of claim 10, wherein the recognition is based on proximity of the portable user tracking device to the directional cones.

12. The programmable electronic training system of claim 10, wherein the user tracking device and the directional cone position device comprise Global Positioning Systems, wherein the recognition is based on a relation between the user position data and the directional cone position data transmitted from the Global Positioning Systems.

13. The programmable electronic training system of claim 10, wherein the network access device comprises the portable user tracking device.

14. The programmable electronic training system of claim 10, wherein the portable user tracking device comprises a secondary communication device.

15. The programmable electronic training system of claim 14, wherein the secondary communication device comprises an active communication device.

16. The programmable electronic training system of claim 14, wherein the secondary communication device comprises a passive communication device.

17. The programmable electronic training system of claim 15, wherein the active communication device comprises a fitness band.

18. The programmable electronic training system of claim 7, wherein the network access device is further caused to verify position of the series of directional cones aligns with the path of the series of directional cones according to the training course information.

19. The programmable electronic training system of claim 1, wherein each directional cone in the series of directional cones further comprises a stabilizing feature configured to stabilize the directional cone on the planar surface.
